(19) United States
(12) Patent Application Publication
(10) Pub. No.: US 2020/0001434 A1
(43) Pub. Date: Jan. 2, 2020

(54) CLAMPING APPARATUS

(71) Applicant: POWER BOX AG, Zug (CH)

(72) Inventor: Andrew Linton, York (GB)

(21) Appl. No.: 16/490,771

(22) PCT Filed: Mar. 6, 2018
(86) PCT No.: PCT/EP2018/055492

§ 371 Date: Sep. 3, 2019

(30) Foreign Application Priority Data
Mar. 7, 2017 (GB) 1703604.7

(51) Int. Cl. B25B 5/00; B25B 5/06; B25H 1/08

(52) U.S. Cl. CPC B25B 5/006; B25H 1/08; B25B 5/068

(57) ABSTRACT

The invention to which this application relates is a clamping mechanism of a type which is adapted to be used with a base (4). The apparatus (2) is provided for use in conjunction with a base (4) to exert a clamping effect on a workpiece (13) with respect to the base (4) and the clamp apparatus (2) includes an elongate shaft (14), a locating portion (52, 6) provided at, or towards one, end of the said shaft, a user operated actuation means selectively located between the said locating portion (52, 6) and the opposing end of the elongate shaft (14). The actuation means are provided with, or connected to, a clamping portion (12) and the locating portion (52, 6) is provided to allow location of the clamp apparatus (2) with respect to engagement means provided on the base (4).

The invention to which this application relates is a clamping mechanism of a type which is adapted to be used with a base. In one example the base may, but need not be, part of a workcentre, an example of which is disclosed in the applicant's co-pending application EP2872296. The apparatus allows a workpiece to be located with respect to the base so that one or more work operations are performed on the same by one or more power tools.

In the co-pending application, the workcentre includes a frame which is located on support legs. The frame defines an aperture into which a base can be fitted and retained. The type of base can be selected from a number of base types ranging from, for example, a base which, in conjunction with the frame upper surface, creates a worktable. The base may include, or be fitted with, a contractor saw power tool, a project saw power tool, or other power tools, or may act as a router power tool mounting table and/or as a work surface. The bases are interchangeable with the frame to allow the user to select a particular function of the workcentre at that time. It should be appreciated that the apparatus as herein described can be used to advantage with other types of workcentres and work tables.

In the use of power tools such as circular saws, flooring saws, tile saws, routers, sanders and the like, the work which is performed by the power tool is performed on a workpiece, such as an item of wood or metal. Part of the requirement of the work operation is for the cut, routing or sanding to be performed in an accurate manner at the required location on the workpiece. In order to achieve this, the conventional approach is either that the apparatus user applies a force by their hand onto the workpiece towards the surface of the base to try and hold the same in a fixed position and/or uses stops, or a conventional screw clamp which can be attached to the edge of the base and clamps the workpiece located on its upper surface. The workpiece therefore has to be positioned so as to contact the one or more stops or clamps to be at least partially located while the power tool is operated.

It is often found that when using the stops, while they may prevent the workpiece from moving in one direction, they do not prevent movement of the workpiece in other directions and/or the use of conventional clamping apparatus, whilst it can provide an improved gripping on the workpiece, is limited by the fact that the clamp has to be mounted at the edge of the base in order to operate and therefore limits the positions at which the clamping effect can be applied to the workpiece. This means that the user of the apparatus often still has to exert a holding pressure on the workpiece using one of their hands. The requirement of the user to use their hand to contact the workpiece while attempting to operate the apparatus to perform the work on the workpiece is, at best, inconvenient, may often lead to the workpiece still moving and causing the work to be inaccurate and, at worst, places the user at risk of injury from the operating power tool.

An aim of the present invention is therefore to provide clamp apparatus which can be used in conjunction with a base to achieve a clamping effect to hold a workpiece in position with respect to the base and to allow the clamping effect to be achieved in an effective manner, thereby freeing up the users to operate the apparatus with both hands.

A further aim is to provide the clamp apparatus and base in a form such that, in combination, the range of locations with respect to the base at which the clamping apparatus can be used is increased, thereby allowing greater certainty that the workpiece can be effectively clamped in position regardless of the required location of the workpiece with respect to the surface of the base.

In a first aspect of the invention there is provided clamp apparatus for use in conjunction with a base to exert a clamping effect on a workpiece to locate the same with respect to the base, said clamp apparatus including an elongate shaft, a locating portion provided at, or towards, one end of the said shaft, a user operable actuation means located between the said locating portion and the opposing end of the elongate shaft, said actuation means provided with, or connected to, a clamping portion to move the same with respect to the elongate shaft and wherein said locating portion is movable with respect to the base to engage the clamp apparatus at a user selected position with the said base.

In one embodiment when the clamp apparatus is engaged with the base, operation of the actuation means causes the clamping portion to be advanced towards or away from the said base. Typically the actuation means is operated once the workpiece which is to be worked on is located between a surface of the base and the clamping portion and the said clamping portion is advanced towards the workpiece by operation of the actuation means until the clamping portion locates a surface of the workpiece opposing the surface which is contact with the base so as to clamp the workpiece in position on the said base.

Typically the operation of the actuation means in a first manner causes movement of the actuation means and clamping portion linearly along the elongate shaft towards the locating portion.

In one embodiment the actuation means can be operated in a second manner so as to allow a reverse movement in which the actuation means and clamping portion can be moved away from the locating portion and so allow a clamped workpiece to be released and/or the gap between the clamping portion and the locating portion to be increased for the next use of the apparatus with a workpiece of a larger size.

In one embodiment the actuation means includes a lever mechanism as part of a handle grip and the lever mechanism is biased to a locking position so, that when the same is at rest, the clamping portion is retained in the selected position along the elongate shaft.

Typically the actuation means includes a pawl arrangement which allows the progressive movement of the actuation means along the elongate member towards the locating portion when the actuation means are operated in the first manner to act in a clamping configuration.

In one embodiment when the clamp apparatus is located with the base, the longitudinal axis of the elongate shaft is substantially perpendicular to the surface of the base towards which the clamping portion can be moved. Typically the direction of movement of the clamping portion when the actuation means is operated is substantially perpendicular to the said surface of the base.

In another embodiment the locating portion is provided to be movable between a first position which allows the clamp apparatus to be moved into a desired location with respect to the base and a second position in which the clamp apparatus is engaged with the base in at least one direction with respect to the surface of the base opposing that on which the workpiece is to be located.

In one embodiment the locating portion is pivotally movable with respect to the elongate shaft so as to be movable between the said first position in which the apparatus can be moved into position so as to achieve engagement of the apparatus with the base, and the second position in which the locating portion contacts and engages with the surface of the base. Typically the locating portion is biased towards the second position.

In one embodiment when in the first position the locating portion and elongate shaft lie along substantially the same and/or parallel axes such that the locating portion and a portion of the elongate shaft to which the locating portion is attached can be passed through a port in the base.

In one embodiment the base is provided with a plurality of said ports in a spaced configuration and the locating portion can be selectively located with any of said ports to provide the clamping apparatus at a suitable location for use.

In one embodiment, the locating portion is formed so as to be received in or on engagement means in the form of a track which is located in or on the base. Typically the track is linear in form and the locating portion can be selectively located along the track so as to allow the clamp apparatus to be movable and selectively located with respect to the base to provide a clamping effect at the desired position on the surface of the base. In one embodiment a plurality of tracks are provided in or on the base.

In a further aspect of the invention there is provided a clamping assembly, said assembly including clamp apparatus and a base, said clamp apparatus provided to contact and exert a clamping effect on a workpiece with respect to the base, said clamp apparatus including an elongate shaft, a locating portion provided at or towards one end of the said shaft, a user operated actuation means selectively located between the said locating portion and the opposing end of the elongate shaft, said actuation means provided with or connected to a clamping portion and wherein said base is provided with one or more ports and/or tracks with which the said locating portion is selectively located so as to selectively position the clamp apparatus with respect to the base.

In one embodiment the multiple engagement means are formed along a track and/or are multiple ports formed in a spaced configuration across the surface of the base on which the workpiece is to be clamped, said ports passing between said surface and the opposing surface of the base.

In one embodiment the locating portion engages with the opposing surface of the base adjacent the particular port through which the elongate shaft of the apparatus passes.

In one embodiment the locating portion is in a first position as the same is passed through the port in a direction from the clamping surface of the base towards the opposing surface of the base and is biased towards a second position such as to move to that second position when the locating portion is free from the port so as to contact the opposing surface of the base.

Specific embodiments of the invention are now described with reference to the accompanying drawings; wherein

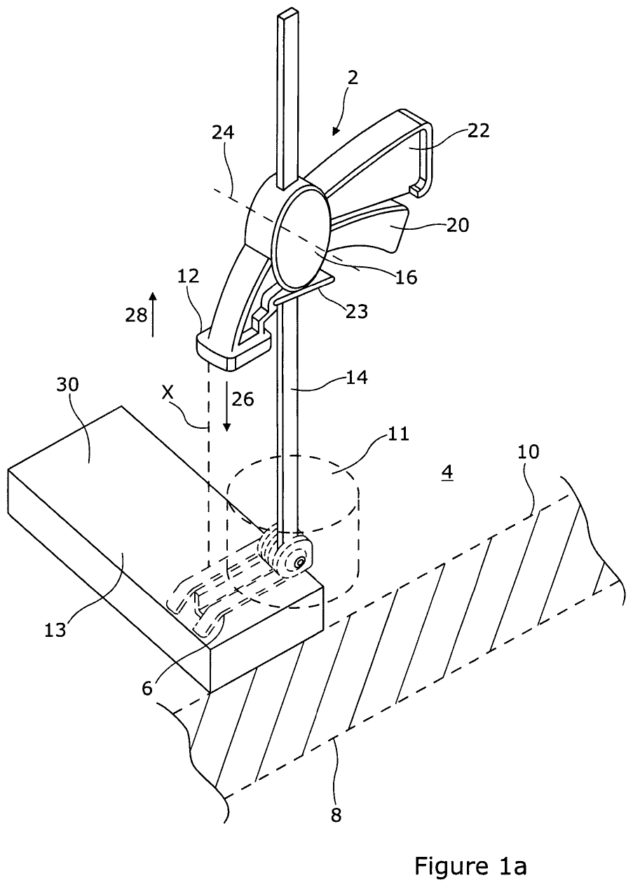

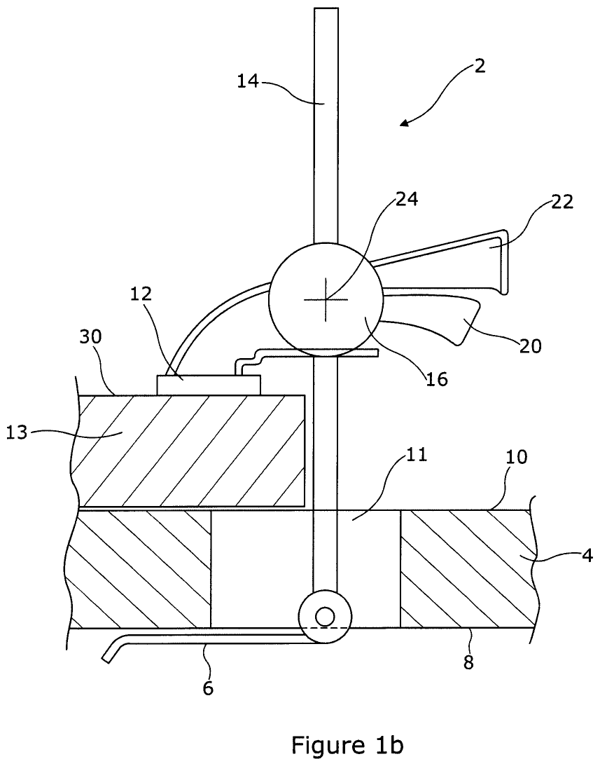

FIGS. 1a and b illustrate the apparatus in accordance with one embodiment of the invention being moved between non-clamping and clamping positions with respect to a workpiece;

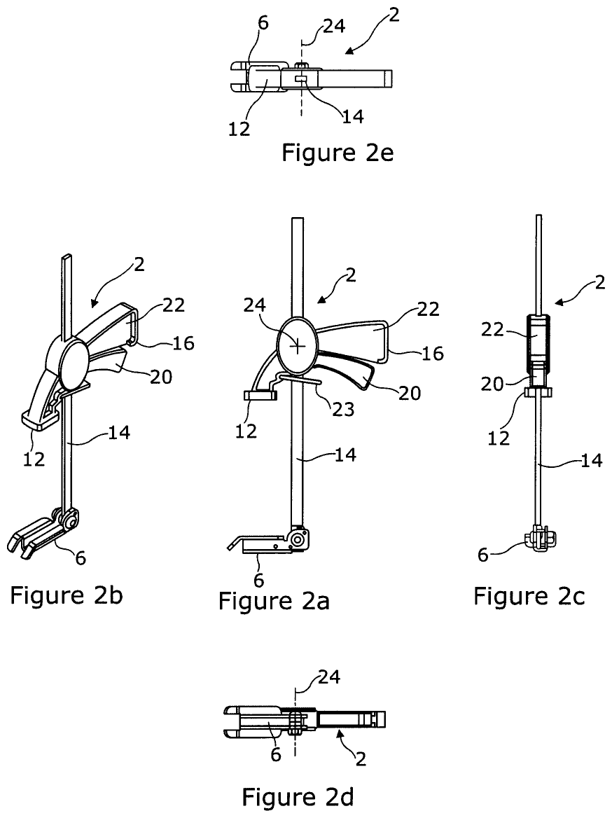

FIGS. 2a-e illustrate the clamp apparatus in accordance with one embodiment of the apparatus;

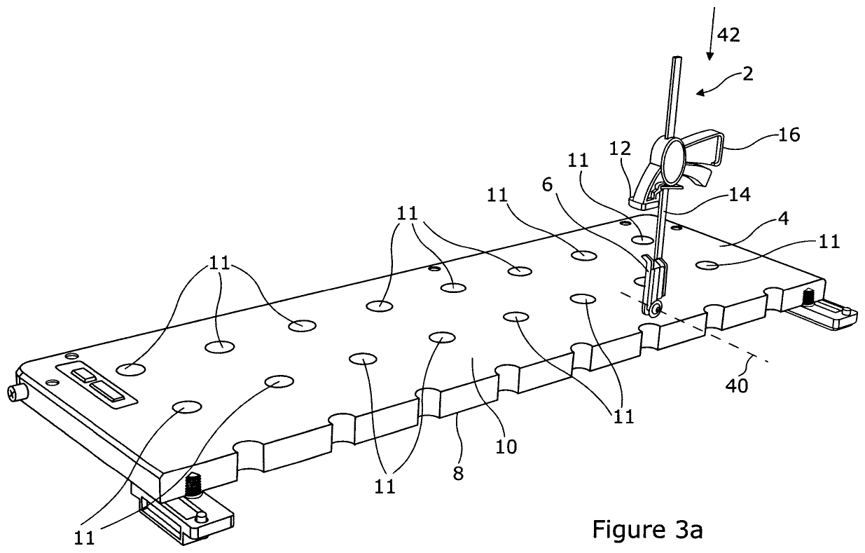

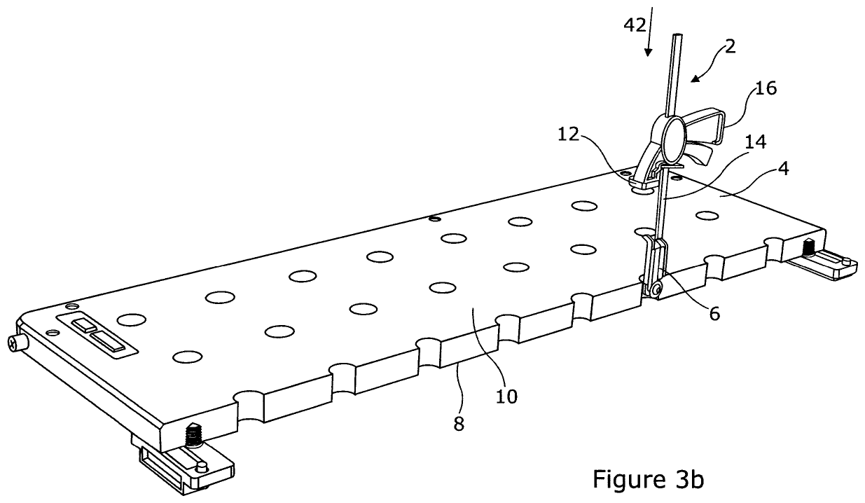

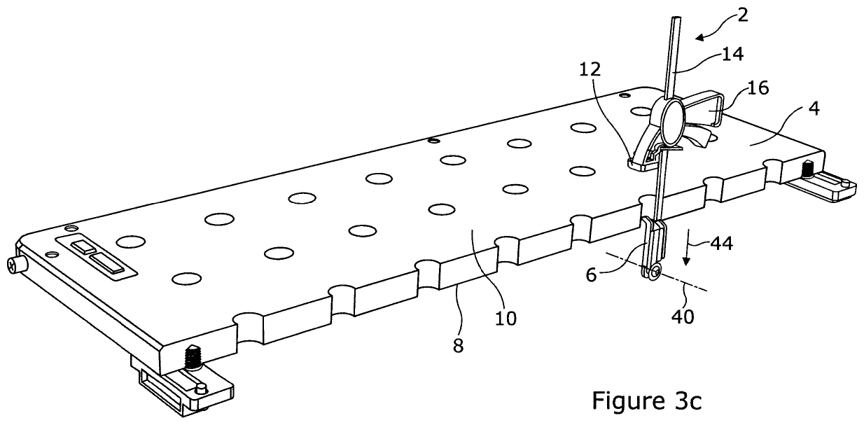

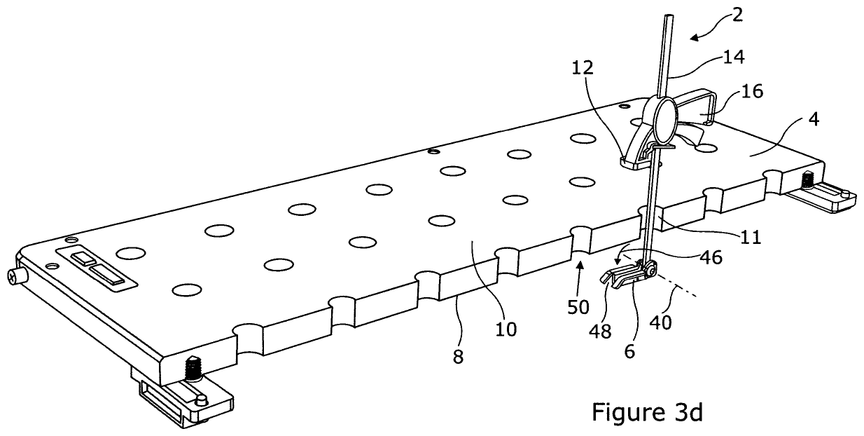

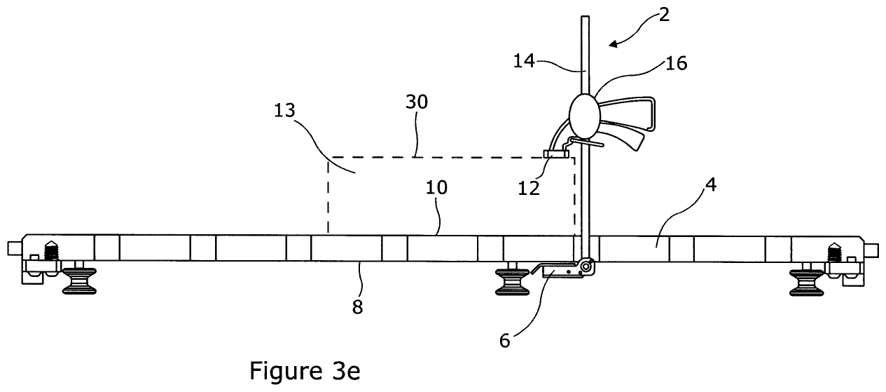

FIGS. 3a-e illustrate the clamp assembly being moved into position using the clamp apparatus of FIGS. 2a-e; and

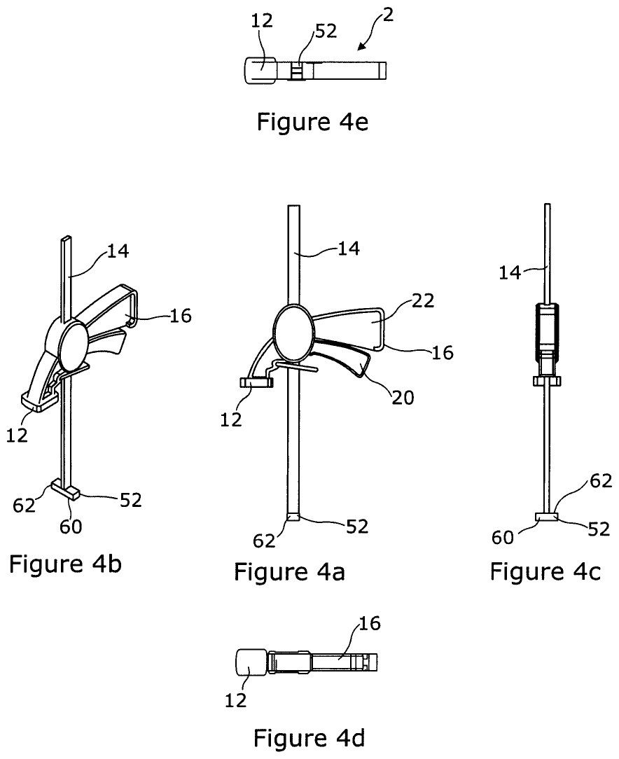

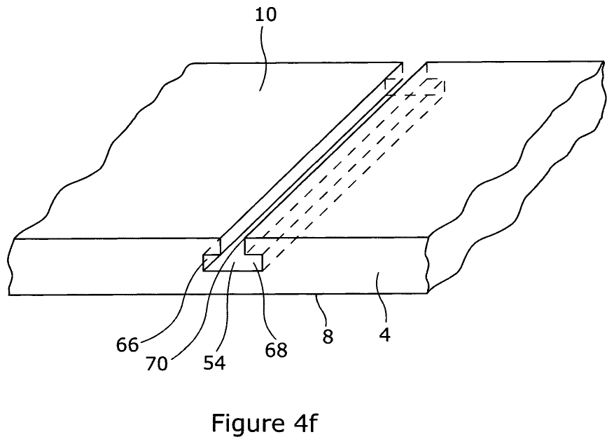

FIGS. 4a-f illustrate clamp apparatus in accordance with a second embodiment.

Referring firstly to FIGS. 1a-b, there is illustrated apparatus in accordance with the first embodiment of the invention in use as part of a clamping assembly. There is provided the clamp apparatus 2 which is located with respect to a base, 4 of a work centre and the assembly is located, in this embodiment, with the base via a locating portion 6 which engages with a surface 8 of the base, which is the opposing surface of the base to the surface on which the workpiece is clamped. The remainder of the apparatus extends through a port 11 in the base so that the remainder of the clamp apparatus is located above the surface 10 of the base onto which the workpiece is to be clamped.

On the surface 10 of the base, there is provided the workpiece 13. Also, typically provided on this side of the base is at least a portion of a power tool (not shown) which is provided to conduct the work on the workpiece.

In order to allow this work to be achieved, the workpiece is desirably clamped in a fixed position on the surface so that the work can be performed accurately, with the workpiece held at a known and desired position. In figure la, the clamp apparatus 2 is shown in a non-clamping position, with a clamping portion 12 at a spaced distance X from the workpiece. The clamping apparatus includes an elongate shaft 14 and, at intermediate ends of the shaft, there is provided an actuation means 16 which, in this embodiment, the damping portion 12 is located. The actuation means is provided with a lever 20 which is pivotally located on a handle or trigger portion 22 at pivot location 24. A movement mechanism is provided in the actuation means in contact with the elongate member such that the pivotal movement of the lever 20, causes movement of the actuation means and clamping portion in a direction 26 towards the workpiece and the base.

The mechanism is a non-return mechanism when in this clamping configuration but the mechanism means can be moved to a release configuration by movement of the stop 23 to disengage the same and so the actuation means clamping portion can be slid in direction 28 away from the workpiece so as to allow the release of the workpiece and adjustment of the position of the clamping portion along the elongate member 14.

In order to move the clamping apparatus from the condition shown in FIG. 1a to a clamping condition shown in FIG. 1b, the lever of the actuation means is operated repeatedly by the user to progressively move the actuation means and clamping portion 12 along the elongate member in the direction 26 so as to eventually bring the clamping portion 12 into contact with the top surface 30 of the workpiece 13. The lever is repeatedly moved until contact has been made and, furthermore, that the contact is sufficient so as to act to clamp the workpiece 13 onto the surface 10 of the base 4 and hence hold the same in position during the work being performed thereon.

It should be appreciated that the relative movement of the clamping portion 12 with respect to the workpiece and base is only possible as a result of the location of the locating portion 6 with the base 4 during the movement of the clamping portion 12 and actuation means. Furthermore, the continual clamping of the workpiece in position relies upon the continued location of the clamp apparatus 2 with the base 4.

FIGS. 2a-e illustrates the clamping apparatus in accordance with the first embodiment and shows the various components which have been described above using the same reference numerals.

FIGS. 3a-e illustrate the stages of movement of the clamping apparatus 2 with respect to the base 4 and show how, whilst the apparatus is being moved into position with respect to the base, the locating portion 6 is movable.

As shown in FIG. 3a the locating portion 6 lies in a first position in which the same lies substantially parallel with the elongate shaft to which the same is connected via a pivotal connection 40. This is because, in this embodiment, the apparatus is provided to be selectively locatable with respect to one of a series of ports 11, which are provided in a spaced configuration across the base 4, as shown. This therefore allows the clamping apparatus to be selectively positioned at the desired one of a range of possible locations on the base so as to provide for the most effective clamping to be achieved at a location which is desired with respect to the particular workpiece being clamped in position at that time.

Thus, in order to move the apparatus into position, the elongate shaft 14 and locating portion 6 are provided to lie substantially flush and thereby be able to fit through the port 11 in the direction 42 as indicated in FIGS. 3a and b. Typically, in order to retain the locating portion in the first position, the user can exert a holding action on the locating portion 6 as it is moved into the port 11 when the apparatus is being moved into position. Once the locating portion 6 and the part of the elongate shaft 14 has passed through the port 11 to be located under the surface 8 of the base 4 as shown in FIG. 3c, the same is moved further as indicated by arrow 44 to a sufficient distance below the underside 8 so that the locating portion end is free of the base and thereby allow biasing means, typically in the form of a torsion spring at axis 40, to cause the locating portion 6 to move to a second, extending, position about the pivot location 40, as indicated by arrow 46 in FIG. 3d. Once in this position, at least the free end 48 of the locating portion extends beyond the opening into the port 11 such that when the clamping apparatus is moved in the direction of arrow 50, the locating portion 6 contacts with the underside 8 of the base 4 and prevents the locating portion 6 from moving back through the port 11. With the clamping apparatus in this location, then the movement of the actuation means 16 along the elongate member 14 causes the clamping portion 12 to come into contact with the top 30 of the workpiece shown in broken lines in FIG. 3e, and hence exert the downward clamping force on the same with respect to the surface 10 of the base 4.

Referring now to FIGS. 4a-4f, there is illustrated a second embodiment of the apparatus and the same reference numerals are used for the same components as in the previous embodiment and the operation of the apparatus to exert a clamping force on the workpiece is the same as previously described and therefore will not be repeated here. The main difference in this embodiment is that the locating portion 52 of the clamping apparatus is provided in a form so as to be located with a track 54 formed on the base 4, one of which is illustrated in FIG. 4f.

Typically, as shown, the track 54 is provided in a linear form and, in one embodiment, a plurality of tracks may be provided on the base 4 and the apparatus can be selectively used with one of the tracks at any given time. The locating portion 52 is provided, in this case, with a T-shaped cross section with the arms 60, 62 of the same being formed so as to be located and trapped in portions 66, 68 of the track so that the clamping apparatus can only be moved linearly along the track and is prevented from being raised away from the track 54, and hence the base, by the reduced neck section 70 of the track 54. Thus, the clamping apparatus 2 can be introduced into the track, typically either from the edge of the base, or via an inserting point along the track and then, once introduced to the track, can be slid along the same to the required position for use. When in the required position, the operation of the actuation means 16 causes the same to be progressively moved along the elongate member 14 towards the workpiece with the locating portion serving to locate and fix the apparatus 2 with respect to the base 4 while this is performed.

It will therefore be appreciated that in accordance with the invention, the movement of the locating portion and actuation means is typically in a direction which is perpendicular to the surface 10 of the base 4 on which the workpiece 13 is to be clamped and provides an effective clamping operation which can be performed efficiently and with one hand.

What is claimed is:

1. Clamp apparatus for use in conjunction with a base to exert a clamping effect on a workpiece to locate the same with respect to the base, said clamp apparatus including an elongate shaft, a locating portion provided at, or towards, one end of the said shaft, a user operable actuation means located between the said locating portion and the opposing end of the elongate shaft, said actuation means provided with, or connected to, a clamping portion to move the same with respect to the elongate shaft and wherein said locating portion is movable with respect to the base to engage the clamp apparatus at a user selected position with the said base.

2. Apparatus according to claim 1 wherein the locating portion is provided to be selectively movable between a first position which allows the clamp apparatus to be moved into a desired location with respect to the base and a second position in which the clamp apparatus is engaged with the base in at least one direction with respect to the surface of the base opposing that onto which the workpiece is to be clamped.

3. Apparatus according to claim 2 wherein the locating portion is pivotally movable with respect to the elongate shaft so as to be movable between the said first position and the second position.

4. Apparatus according to claim 3 wherein the locating portion is biased towards the second position.

5. Apparatus according to claim 2 wherein when in the first position the locating portion and elongate shaft lie along substantially the same axis such that the locating portion and a portion of the elongate shaft pass through a port in the base.

6. Apparatus according to claim 5 wherein the base is provided with a plurality of said ports in a spaced configuration and the apparatus can be selectively located with any of the said ports to provide the clamping apparatus at a required location for use.

7. Apparatus according to claim 1 wherein operation of the actuation means in a first manner causes the actuation means and clamping portion to be advanced along the elongate shaft towards the said locating portion.

8. Apparatus according to claim 7 wherein the movement of the actuation means advances the clamping portion towards the locating portion until contact is made with a workpiece located on the base between the clamping portion and the locating portion so that the workpiece is clamped in position on the base.

9. Apparatus according to claim 8 wherein operation of the actuation means in a second manner causes the actuation means and clamping portion to be moved along the elongate shaft away from the locating portion and allows the workpiece to be released and/or the gap between the clamping portion and the locating portion to be increased.

10. Apparatus according to claim 1 wherein the actuation means includes a lever mechanism as part of a handle grip and the lever mechanism is biased to a locking position so that when the same is at rest, the clamping portion is retained in position along the elongate shaft.

11. Apparatus according to claim 10 wherein the actuation means includes a pawl arrangement which when the actuation means is operated in a first manner allows progressive movement of the actuation means along the elongate shaft towards locating portion.

12. Apparatus according to claim 1 wherein when the clamp apparatus is located with the base, the longitudinal axis of the elongate shaft is substantially perpendicular to a surface of the base on which the workpiece to be clamped is positioned.

13. Apparatus according to claim 12 wherein the direction of movement of the clamping portion when the actuation means is operated is substantially perpendicular to the said surface of the base.

14. Apparatus according to claim 1 wherein the locating portion is provided with a formation to be received in or on a track located in or on the base.

15. Apparatus according to claim 14 wherein said track is linear in form and the locating portion is selectively movable along the track so as to allow the apparatus to be selectively located with respect to the base to provide a clamping effect at the desired position on the surface of the base.

16. A clamping assembly, said assembly including clamp apparatus and a base, said clamp apparatus provided to contact and exert a clamping effect on a workpiece with respect to the base, said clamp apparatus including an elongate shaft, a locating portion provided at or towards one end of the said shaft, a user operated actuation means selectively located between the said locating portion and the opposing end of the elongate shaft, said actuation means provided with or connected to a clamping portion and wherein said base is provided with one or more ports and/or tracks with which the said locating portion is selectively located so as to selectively position the clamp apparatus with respect to the base.

17. An assembly according to claim 16 wherein multiple ports are formed in a spaced configuration across the base and which extend from a first surface of the base on which the workpiece is to be located and the opposing base surface.

18. An assembly according to claim 17 wherein the locating portion engages with the said opposing surface of the base adjacent to a particular port through which the elongate shaft of the clamp apparatus passes.

19. An assembly according to claim 18 wherein the locating portion is provided in a first position as the same is passed through the port from the first surface towards the opposing surface of the base and is biased towards a second position when the locating portion is free from the port so as to contact the opposing surface of the base.

20. An assembly according to claim 16 wherein the multiple tracks are provided on or in the base.
